(19) United States
(12) Patent Application Publication
(10) Pub. No.: US 2019/0265766 A1
(43) Pub. Date: Aug. 29, 2019

(54) VOLTAGE CONTROL APPARATUS, VOLTAGE CONTROL METHOD, AND RECORDING MEDIUM

(71) Applicant: FUJITSU LIMITED, Kawasaki-shi (JP)

(72) Inventors: TAKAYA TANIGUCHI, Fukuoka (JP); Tatsuya YAMAGUCHI, Chikusino (JP)

(73) Assignee: FUJITSU LIMITED, Kawasaki-shi (JP)

(21) Appl. No.: 16/269,823

(22) Filed: Feb. 7, 2019

(30) Foreign Application Priority Data
Feb. 23, 2018 (JP) 2018-030293

(51) Int. Cl. G06F 1/26

(52) U.S. Cl. CPC G06F 1/266

(57) ABSTRACT

A voltage control apparatus includes a processor. The processor sets an intermediate voltage output from a first device in a first period to a first voltage, changes the intermediate voltage from the first voltage to a second voltage, returns the second voltage in a second period to the first voltage, detects a first and a second input power of the first device corresponding to the first and the second period, detects a third input power of the first device when the second voltage is output from the first device, when a difference between the first input power and the second input power is equal to or smaller than a threshold value, detects a minimum input power of the first input power and the third input power, and controls the intermediate voltage output by setting the intermediate voltage when the minimum input power is applied to the first device.

### CROSS-REFERENCE TO RELATED APPLICATION

This application is based upon and claims the benefit of priority of the prior Japanese Patent Application No. 2018-030293, filed on Feb. 23, 2018, the entire contents of which are incorporated herein by reference.

### FIELD

The embodiments discussed herein are related to a voltage control apparatus, a voltage control method, and a recording medium.

### BACKGROUND

The power consumption of electronic devices has been increasing year by year becoming a large scale power consumption, and the demand for power saving is accordingly increasing. In order to meet such a demand, in recent years, a power supply system has been changed from a centralized power supply system in which power is supplied to all the loads with a single output power supply to a distributed power supply system in which power is supplied to the loads from plural power supplies arranged for the respective loads.

In the distributed power supply system, for example, one insulated converter (bus converter) converts an input voltage to an intermediate bus voltage, and plural non-insulated converters (POL: Point Of Load) convert the intermediate bus voltage to a predetermined level of voltage which is then supplied to the loads.

In the meantime, power loss occurs during voltage conversion. In order to reduce the power consumption of the system, it is important to reduce the power loss and it is required to improve the power conversion efficiency of the bus converter and the POL (hereinafter, referred to as a conversion efficiency).

Related techniques are disclosed in, for example, Japanese Laid-open Patent Publication Nos. 2015-192549 and 2008-148473.

### SUMMARY

According to an aspect of the embodiments, a voltage control apparatus includes a processor. The processor sets an intermediate voltage output from a first device in a first period to a first voltage, changes the intermediate voltage from the first voltage to a second voltage, returns the second voltage in a second period to the first voltage, detects a first and a second input power of the first device corresponding to the first and the second period, detects a third input power of the first device when the second voltage is output from the first device, when a difference between the first input power and the second input power is equal to or smaller than a threshold value, detects a minimum input power of the first input power and the third input power, and controls the intermediate voltage output by setting the intermediate voltage when the minimum input power is applied to the first device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A and 1B are views illustrating an example of the configuration of a voltage control apparatus;

FIG. 2 is a view illustrating an example of the configuration of a distributed power supply system;

FIG. 3 is a view illustrating an example of an operation of searching for an intermediate bus voltage when the output power of a POL is constant;

FIG. 4 is a view illustrating an example of an operation of searching for an intermediate bus voltage when the output power of the POL varies;

FIG. 5 is a view illustrating an example of the configuration of a power supply system;

FIG. 6 is a view illustrating an example of functional blocks of an input power monitor and a voltage control apparatus;

FIG. 7 is a view illustrating an example of functional blocks of a voltage control circuit;

FIG. 8 is a view illustrating an example of a hardware configuration of the voltage control circuit;

FIG. 9 is a view for explaining an operation of determining an optimal value of an intermediate bus voltage;

FIG. 10 is a flowchart illustrating an operation of determining an optimal value of an intermediate bus voltage;

FIG. 11 is a view for explaining a modification of the operation of determining the optimal value of the intermediate bus voltage;

FIG. 12 is a view for explaining a modification of the operation of determining the optimal value of the intermediate bus voltage;

FIGS. 13A and 13B are views illustrating the conversion efficiency of a POL and a bus converter; and

FIG. 14 is a view illustrating a relationship between an intermediate bus voltage and power consumption.

### DESCRIPTION OF EMBODIMENTS

The magnitude of input power of a bus converter is proportional to the power loss of the bus converter and a POL. Therefore, the conversion efficiency of the bus converter and the POL may be enhanced by outputting an intermediate bus voltage adjusted to minimize the input power from the bus converter.

In this case, under the condition that the output power of the POL becomes constant, it is possible to detect the intermediate bus voltage that minimizes the input power of the bus converter. In the meantime, under the condition that the output power of the POL is not constant, the input power of the bus converter also decreases following the decrease of the output power of the POL. In this case, there is a possibility of erroneously detecting the intermediate bus voltage at this time as a value of enhancing the conversion efficiency by considering the input power decreased following the change in the output power as the minimum.

In order to prevent such an erroneous detection, it is conceivable, for example, to provide a monitor circuit that measures the output power of the POL and to monitor the change in the output power through the monitor circuit. However, since a monitor circuit is provided for each of plural POLs, the circuit scale increases and an additional power loss occurs due to the additional monitor circuit.

Hereinafter, embodiments will be described with reference to the accompanying drawings.

### First Embodiment

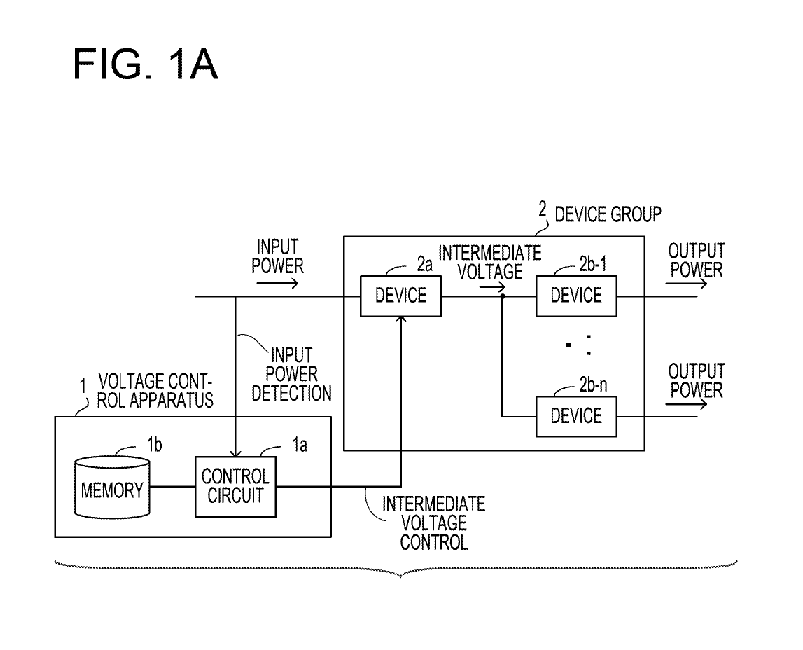

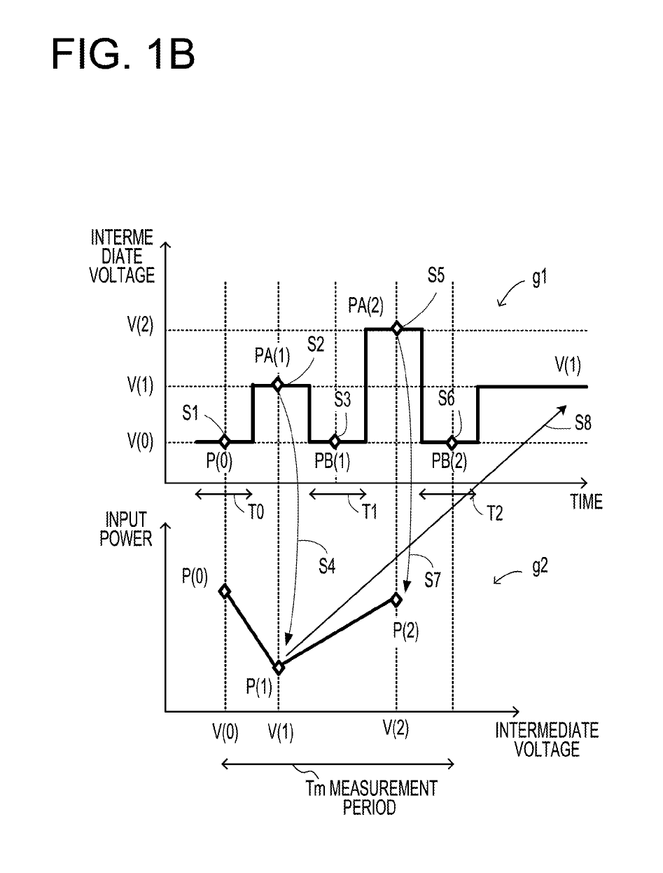

A first embodiment will be described with reference to FIGS. 1A and 1B. FIGS. 1A and 1B are views illustrating an example of the configuration of a voltage control apparatus. The voltage control apparatus 1 is connected to a device group 2 that includes a device 2a (first device) and devices 2b-1 to 2b-n (second device). The device 2a outputs an intermediate voltage and the devices 2b-1 to 2b-n receive the intermediate voltage as an input. The voltage control apparatus 1 includes a control circuit 1a and a memory 1b, and controls the intermediate voltage applied to a line (bus) that couples the device 2a and the devices 2b-1 to 2b-n.

The control circuit 1a sets the intermediate voltage output from the device 2a to a first voltage in a first period and changes the intermediate voltage from the first voltage to one or more second voltages different from the first voltage. The control circuit 1a returns the second voltage in the transition period of the intermediate voltage to the first voltage in a second period.

In addition, the control circuit 1a detects first input power of the device 2a when the first voltage is output from the device 2a in the first period and further detects second input power of the device 2a when the first voltage is output from the device 2a in the second period.

Then, the control circuit 1a monitors a change in output power of the devices 2b-1 to 2b-n based on a difference between the first input power and the second input power. The memory 1b stores, for example, intermediate voltage data obtained when the control circuit 1a transitions the intermediate voltage of the device 2a, and data on the input power detected by the control circuit 1a. Further, the memory 1b stores control information related to the operation of the voltage control apparatus 1.

The operation will be described below with reference to FIGS. 1A and 1B. A graph g1 represents the transition state of the intermediate voltage output by the device 2a in which the vertical axis represents the intermediate voltage and the horizontal axis represents time. A graph g2 represents the transition state of the input power of the device 2a in which the vertical axis represents the input power and the horizontal axis represents the intermediate voltage.

[Step S1] The control circuit 1a sets a reference intermediate voltage to an intermediate voltage V(0) and outputs the intermediate voltage V(0) from the device 2a in a period T0. Further, the control circuit 1a detects input power P(0) of the device 2a when the intermediate voltage V(0) is output from the device 2a, and stores the input power P(0) in the memory 1b.

[Step S2] The control circuit 1a increases the intermediate voltage of the device 2a from the intermediate voltage V(0) and sweeps the intermediate voltage of the device 2a to an intermediate voltage V(1). Further, the control circuit 1a detects input power PA(1) of the device 2a when the intermediate voltage V(1) is output from the device 2a.

[Step S3] The control circuit 1a returns the intermediate voltage of the device 2a from the intermediate voltage V(1) to the intermediate voltage V(0), and outputs the intermediate voltage V(0) from the device 2a in a period T1. Further, the control circuit 1a detects input power PB(1) of the device 2a when the intermediate voltage of the device 2a is returned to the intermediate voltage V(0).

[Step S4] The control circuit 1a compares the input power P(0) in the period T0 with the input power PB(1) in the period T1 to determine whether a difference between the input power P(0) and the input power PB(1) is equal to or smaller than a threshold value.

When the difference is equal to or smaller than the threshold value, the control circuit 1a determines that a change in the output power of the devices 2b-1 to 2b-n is within an allowable range, and sets the input power PA(1) as input power data P(1) and stores the input power PA(1) in the memory 1b.

[Step S5] The control circuit 1a increases the intermediate voltage of the device 2a from the intermediate voltage V(0) and sweeps the intermediate voltage of the device 2a to an intermediate voltage V(2). Further, the control circuit 1a detects input power PA(2) of the device 2a when the intermediate voltage V(2) is output from the device 2a.

[Step S6] The control circuit 1a returns the intermediate voltage of the device 2a from the intermediate voltage V(2) to the intermediate voltage V(0), and outputs the intermediate voltage V(0) from the device 2a in a period T2. Further, the control circuit 1a detects input power PB(2) of the device 2a when the intermediate voltage of the device 2a is returned to the intermediate voltage V(0).

[Step S7] The control circuit 1a compares the input power P(0) in the period T0 with the input power PB(2) in the period T2 to determine whether a difference between the input power P(0) and the input power PB(2) is equal to or smaller than a threshold value.

When the difference is equal to or smaller than the threshold value, the control circuit 1a determines that a change in the output power of the devices 2b-1 to 2b-n is within an allowable range, and sets the input power PA(2) as input power data P(2) and stores the input power PA(2) in the memory 1b.

[Step S8] The control circuit 1a detects the minimum input power P(1) among the input powers P(0), P(1), and P(2) acquired during a measurement period Tm. Then, the control circuit 1a determines the intermediate voltage V(1) at the input power P(1), and controls the device 2a to output the intermediate voltage V(1) during operation of the device 2a.

In this way, the voltage control apparatus 1 transitions the intermediate voltage of the device 2a, and monitors a change in the output power of the devices 2b-1 to 2b-n from a change in the input power of the device 2a, based on a difference between the input power at the reference intermediate voltage and the input power at the time of returning to the reference intermediate voltage during the transition period. As a result, the voltage control apparatus 1 may adjust and determine the optimal intermediate voltage that enhances the conversion efficiency, with no need to provide, for example, a monitor circuit for the output power.

### Second Embodiment

A second embodiment involves a distributed power supply system to which the voltage control apparatus 1 is applied. First, the configuration of a power supply system of a general distributed power supply system will be described.

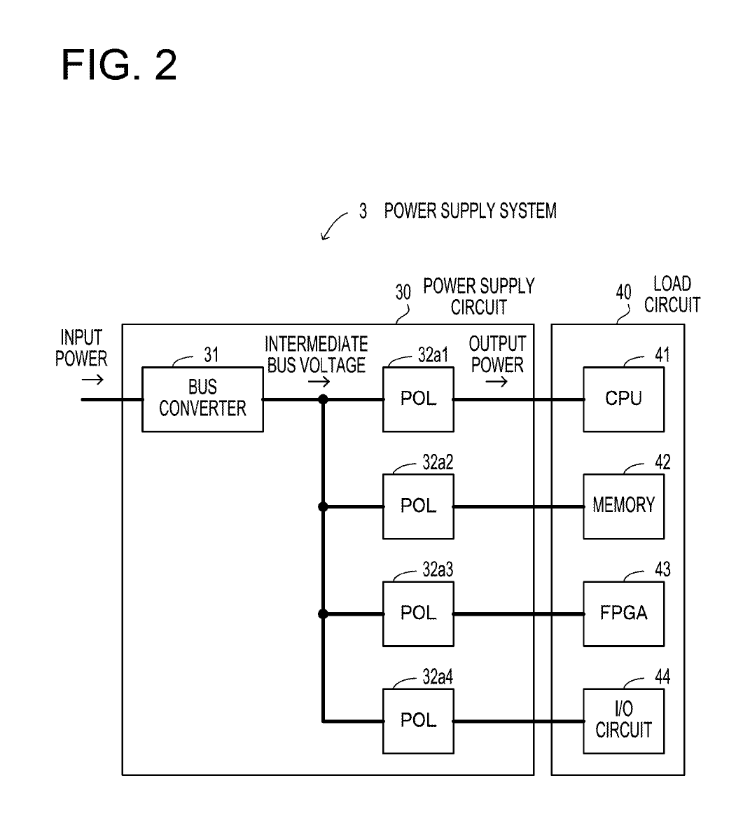

FIG. 2 is a view illustrating an example of the configuration of a power supply system of a distributed power supply system. The power supply system 3 includes a power supply circuit 30 and a load circuit 40. The power supply circuit 30 includes a bus converter 31 and POLs 32a1 to 32a4 which are load drive converters (which may be collectively referred to as a POL 32).

The load circuit 40 includes, for example, a CPU (Central Processing Unit) 41, a memory 42, an FPGA (Field Programmable Gate Array) 43, and an I/O (input/output interface) circuit 44.

The bus converter 31 is coupled by a bus to the POLs 32a1 to 32a4. The POL 32a1 is coupled to the CPU 41 and the POL 32a2 is coupled to the memory 42. The POL 32a3 is coupled to the FPGA 43 and the POL 32a4 is coupled to the I/O circuit 44.

A bus that couples the bus converter 31 and the POLs 32a1 to 32a4 is called an intermediate bus, and a voltage applied to the intermediate bus is called an intermediate bus voltage. The bus converter 31 is, for example, an insulated DC/DC converter, and converts an applied input voltage into an input voltage of the POL 32a1 to 32a4 (intermediate bus voltage).

The bus converter 31, which is of an insulation type, includes a primary side circuit unit to which an input voltage is applied and a secondary side circuit unit which converts the input voltage and outputs an intermediate bus voltage. The primary side circuit unit and the secondary side circuit unit are electrically isolated from each other and magnetically connected to each other by a transformer.

Therefore, in the bus converter 31, when an electrical short circuit occurs on one of the primary side and the secondary side, it is possible to prevent the influence from being transmitted to the other side. For example, even when an overvoltage occurs in the primary circuit unit, it is possible to protect a device coupled to the secondary circuit unit.

The POLs 32a1 to 32a4 are, for example, non-insulated DC/DC converters. The POL 32a1 is disposed in the vicinity of the CPU 41 and converts the intermediate bus voltage into an output voltage required for the operation of the CPU 41. The POL 32a2 is disposed in the vicinity of the memory 42 and converts the intermediate bus voltage into an output voltage required for the operation of the memory 42.

The POL 32a3 is disposed in the vicinity of the FPGA 43 and converts the intermediate bus voltage into an output voltage required for the operation of the FPGA 43. POL 32a4 is disposed in the vicinity of the I/O circuit 44 and converts the intermediate bus voltage to an output voltage required for the operation of the I/O circuit 44.

### Search for Optimal Value of Intermediate Bus Voltage

Next, a search for an optimal value of the intermediate bus voltage in the power supply system 3 will be described. The optimal value of the intermediate bus voltage is a value that maximizes the conversion efficiency of the power supply circuit 30, that is, the conversion efficiency of both the bus converter 31 and the POL 32.

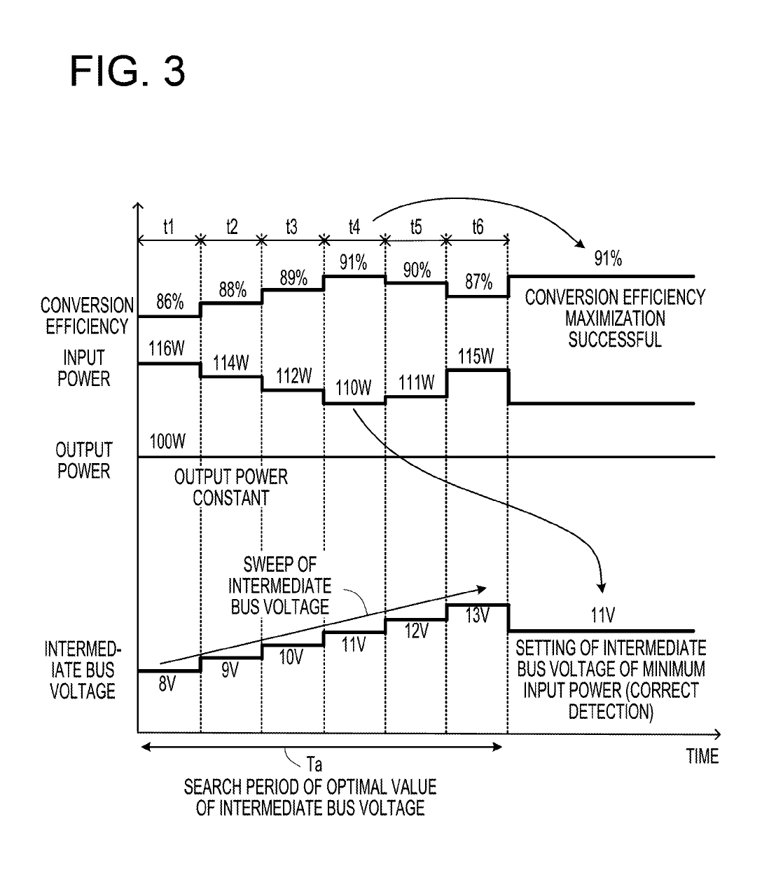

FIG. 3 is a view illustrating an example of an operation of searching for an intermediate bus voltage when the output power of the POL is constant. The vertical axis represents the conversion efficiency of the power supply circuit 30, the input power of the bus converter 31, the output power of the POL 32, and an intermediate bus voltage, in order from the top. The horizontal axis represents time.

A search period Ta is a period during which the optimal value of the intermediate bus voltage that maximizes the conversion efficiency of the power supply circuit 30 is searched for. In the search period Ta, the intermediate bus voltage output from the bus converter 31 is swept in the unit of 1V from 8V to 13V. In the example of FIG. 3, it is assumed that the output power of the POL 32 is constant at 100 W through the search period Ta.

[Period t1] When the intermediate bus voltage is 8V, the input power of the bus converter 31 is measured to be 116 W. Since the output power of the POL 32 is 100 W, the conversion efficiency at this time is calculated as 86%. The conversion efficiency is calculated by conversion efficiency (%)=(output power input power)×100.

[Period t2] When the intermediate bus voltage is 9V, the input power of the bus converter 31 is measured as be 114 W. Since the output power of POL 32 is 100 W, the conversion efficiency at this time is calculated as 88%.

[Period t3] When the intermediate bus voltage is 10V, the input power of the bus converter 31 is measured to be 112 W. Since the output power of the POL 32 is 100 W, the conversion efficiency at this time is calculated as 89%.

[Period t4] When the intermediate bus voltage is 11V, the input power of the bus converter 31 is measured to be 110 W. Since the output power of POL 32 is 100 W, the conversion efficiency at this time is calculated as 91%.

[Period t5] When the intermediate bus voltage is 12V, the input power of the bus converter 31 is measured to be 111 W. Since the output power of the POL 32 is 100 W, the conversion efficiency at this time is calculated as 90%.

[Period t6] When the intermediate bus voltage is 13V, the input power of the bus converter 31 is measured to be 115 W. Since the output power of the POL 32 is 100 W, the conversion efficiency at this time is calculated as 87%.

Here, the input power to the bus converter 31 is the sum of the output power of the POL 32 and the power loss of the power supply circuit 30. Therefore, the conversion efficiency of the power supply circuit 30 including the bus converter 31 and the POL 32 may be maximized by causing the bus converter 31 to output an intermediate bus voltage that minimizes the input power.

That is, the intermediate bus voltage at which the input power of the bus converter 31 becomes the minimum becomes the optimal value. By setting the intermediate bus voltage in the bus converter 31 so as to obtain the optimal value, low power consumption may be implemented.

In the example of FIG. 3, the conversion efficiency at the minimum value 110 W of input power is set to be the highest at 91%. Therefore, the intermediate bus voltage (=11V) when the input power is measured to be 110 W is detected as the optimal value.

After the end of the search period Ta, the intermediate bus voltage of the bus converter 31 is set to 11V, whereby the conversion efficiency of the power supply circuit 30 may be maximized as 91%.

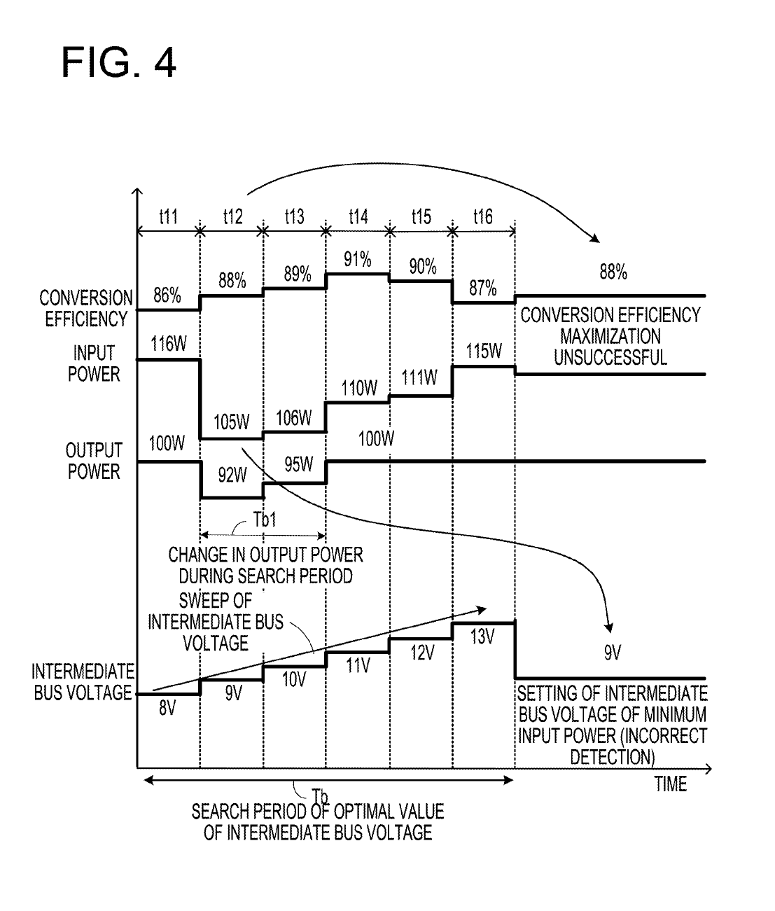

FIG. 4 is a view illustrating an example of an operation of searching for an intermediate bus voltage when the output power of the POL varies. The vertical axis represents the conversion efficiency of the power supply circuit 30, the input power of the bus converter 31, the output power of the POL 32, and an intermediate bus voltage, in order from the top. The horizontal axis represents time.

A search period Tb is a period during which the optimal value of the intermediate bus voltage that maximizes the conversion efficiency of the power supply circuit 30 is searched for. In the search period Tb, the intermediate bus voltage is swept in the unit of 1V from 8V to 13V. In the example of FIG. 4, it is assumed that a change in the output power occurs in a period Tb during the search period Tb.

[Period t11] When the intermediate bus voltage is 8V, the input power of the bus converter 31 is measured to be 116 W, and the output power of the POL 32 is measured to be 100 W. The conversion efficiency at this time is calculated as 86%.

[Period t12] When the intermediate bus voltage is 9V, the input power of the bus converter 31 is measured to be 105 W, and the output power of the POL 32 is measured to be 92 W. The conversion efficiency at this time is calculated as 88%.

[Period t13] When the intermediate bus voltage is 10V, the input power of the bus converter 31 is measured to be 106 W, and the output power of the POL 32 is measured to be 95 W. The conversion efficiency at this time is calculated as 89%.

[Period t14] When the intermediate bus voltage is 11V, the input power of the bus converter 31 is measured to be 110 W, and the output power of the POL 32 is measured to be 100 W. The conversion efficiency at this time is calculated as 91%.

[Period t15] When the intermediate bus voltage is 12V, the input power of the bus converter 31 is measured to be 111 W, and the output power of the POL 32 is measured to be 100 W. The conversion efficiency at this time is calculated as 90%.

[Period t16] When the intermediate bus voltage is 13V, the input power of the bus converter 31 is measured to be 115 W, and the output power of the POL 32 is measured to be 100 W. The conversion efficiency at this time is calculated as 87%.

The search period Tb includes the period Tb1 during which the output power of the POL 32 changes. When the output power decreases in the period Tb1, there is a possibility of erroneously detecting the intermediate bus voltage as the optimal value by adopting the input power decreased following the decrease of the output power as the minimum.

In the example of FIG. 4, since the input power of the bus converter 31 becomes the minimum (105 W) when the output power of the POL 32 becomes 92 W, the intermediate bus voltage 9V is detected as the optimal value at this time. However, the conversion efficiency when the intermediate bus voltage is 9V is 88%, and the highest conversion efficiency of 91% is present in the search period Tb.

Originally, the intermediate bus voltage 11V needs to be detected as the optimal value, which achieves the conversion efficiency of 91%, but the output power of the POL 32 changes so that accurate optimal value detection may not be performed. When such an erroneous detection occurs, since an intermediate bus voltage at which the conversion efficiency becomes maximum may not be set so that it is impossible to maximize the conversion efficiency of the power supply circuit 30.

In the meantime, it is conceivable to provide a monitor circuit that measures the output power at the subsequent stage of the POL 32 to monitor the change in the output power and to search for the optimal value according to the monitoring result, but the addition of the monitor circuit increases the circuit scale and the power loss by the monitor circuit itself occurs.

The present disclosure has been made in view of these circumstances, and provides eliminating the need for a monitor circuit for output power, detecting an optimal value of an intermediate bus voltage with high precision based on the monitoring of the input power, and adjusting and determining an optimal intermediate bus voltage that increases the conversion efficiency.

### System Configuration

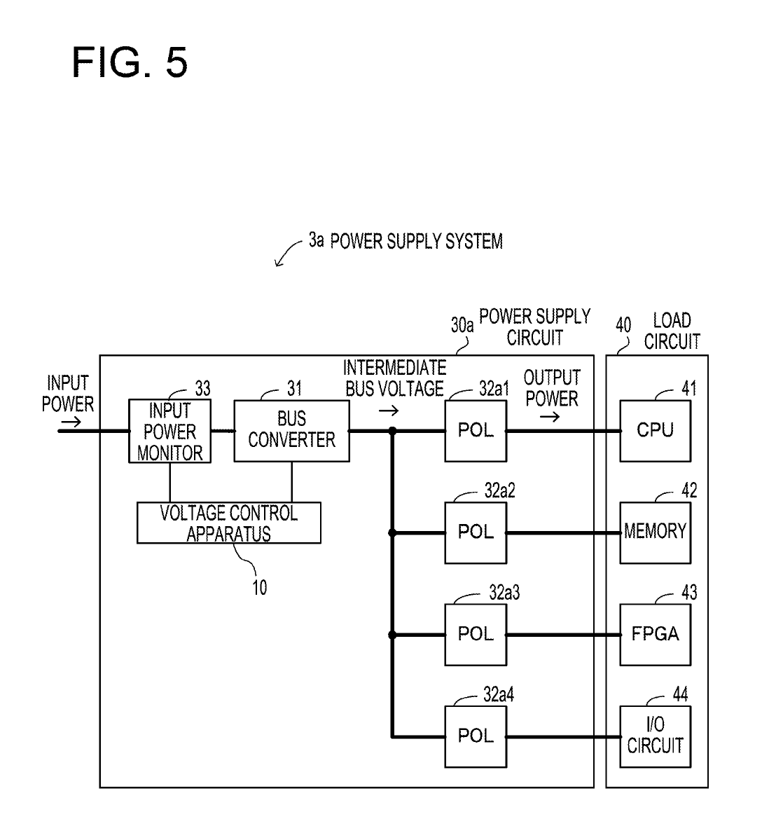

The second embodiment will be described in more detail below. FIG. 5 is a view illustrating an example of the configuration of the power supply system. The power supply system 3a includes a power supply circuit 30a and a load circuit 40. The power supply circuit 30a includes a bus converter 31, POLs 32a1 to 32a4, an input power monitor 33, and a voltage control apparatus 10. The configurations other than the input power monitor 33 and the voltage control apparatus 10 are the same as those in FIG. 2.

The input power monitor 33 detects the input power of the bus converter 31. The voltage control apparatus 10 has the same function as that of the voltage apparatus device 1 illustrated in FIGS. 1A and 1B. The voltage control apparatus 10 detects the optimal value of the intermediate bus voltage output from the bus converter 31 and performs voltage control related to the setting of the optimal value in the bus converter 31.

### Functional Block

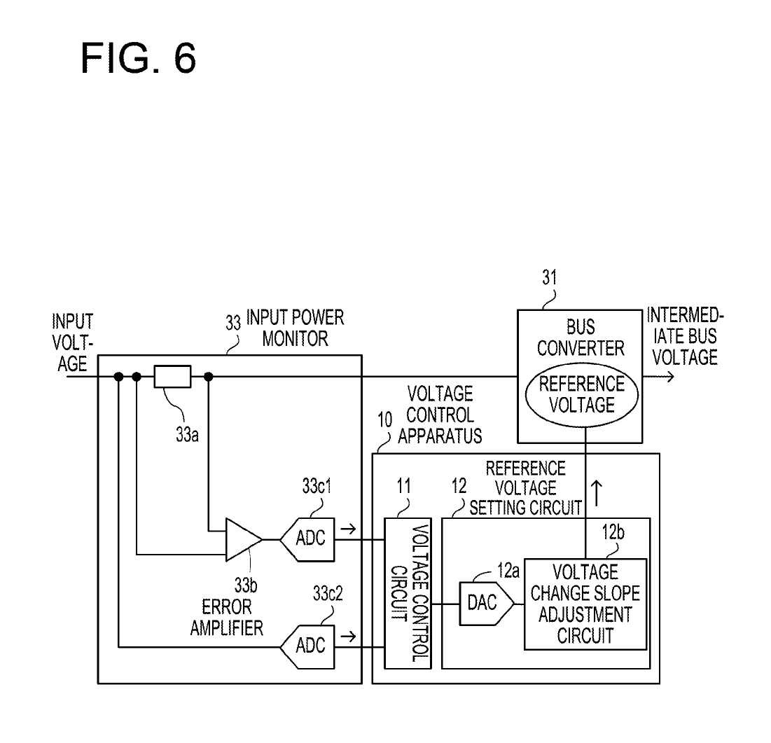

FIG. 6 is a view illustrating an example of functional blocks of the input power monitor and the voltage control apparatus. The input power monitor 33 includes a resistor 33a, an error amplifier 33b, and AC/DC converters (ADCs) 33c1 and 33c2.

The voltage control apparatus 10 includes a voltage control circuit 11 and a reference voltage setting unit 12. The reference voltage setting unit 12 includes a DAC (DC/AC converter) 12a and a voltage change slope adjustment circuit 12b. The voltage control circuit 11 detects the optimal value of the intermediate bus voltage and generates a command that outputs the optimal intermediate bus voltage from the bus converter 31. The reference voltage setting unit 12 changes the reference voltage of the bus converter 31 based on the command.

Here, an input voltage is applied to one end of the resistor 33a. One input terminal of the error amplifier 33b and the input terminal of the ADC 33c2 are coupled to the one end of the resistor 33a. The other end of the resistor 33a is coupled to the input terminal of the bus converter 31 and the other input terminal of the error amplifier 33b.

The resistor 33a functions as a resistor that detects an input current when an input voltage is applied. The error amplifier 33b detects a voltage across the resistor 33a, measures the input current, and outputs the measurement result.

The ADC 33c1 A/D-converts the output signal from the error amplifier 33b to generate a digitized input current signal. The ADC 33c2 A/D-converts the input voltage to generate a digitized input voltage signal.

The voltage control circuit 11 receives the input current signal and the input voltage signal and calculates input power by digital calculation based on the acquired input current and input voltage values (input power=input voltage×input current).

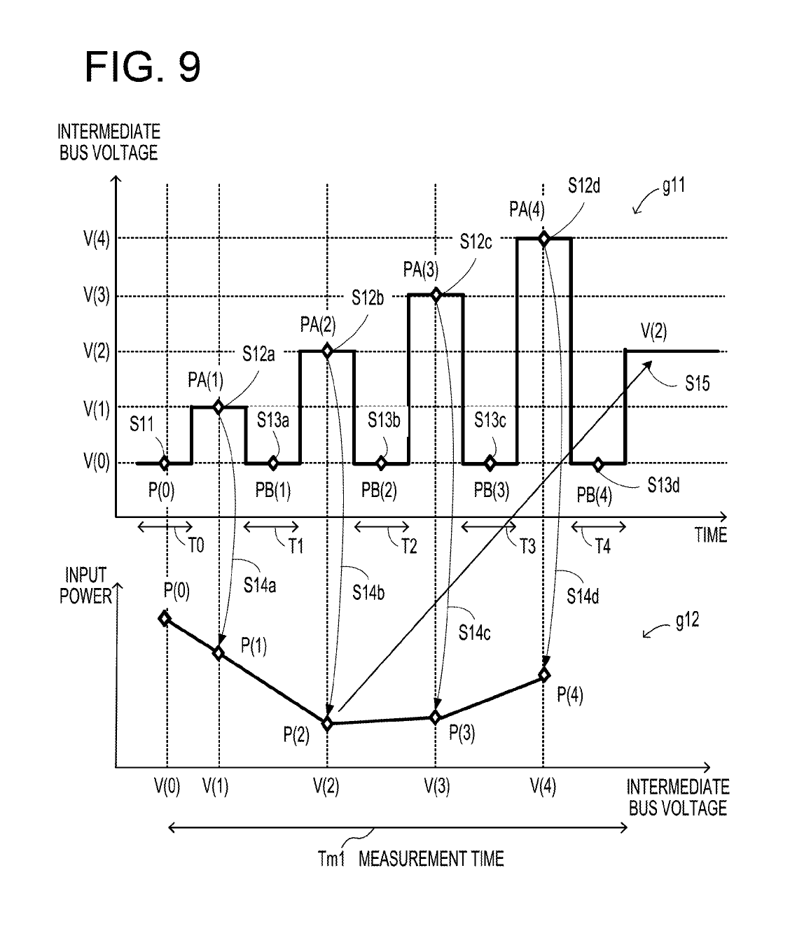

Further, the voltage control circuit 11 sends a command of repeating a change of the intermediate bus voltage at a constant voltage step to the bus converter 31 to sweep the intermediate bus voltage (to be described later with reference to FIG. 9). Further, the voltage control circuit 11 determines the optimal value of the intermediate bus voltage when the input power becomes the minimum, and outputs a digital signal of the determined intermediate bus voltage.

The DAC 12a D/A-converts the digital signal output from the voltage control unit 11 and converts the digital signal into an analog signal. Based on the analog signal output from the DAC 12a, the voltage change slope adjustment circuit 12b adjusts a voltage change slope and inputs the voltage change slope to the bus converter 31 to adjust the reference voltage of the bus converter 31 (it is also possible to control the bus voltage with PWM (Pulse Width Modulation) control).

Since the output voltage (intermediate bus voltage) of the bus converter 31 changes as the reference voltage of the bus converter 31 changes, the voltage control apparatus 10 changes the intermediate bus voltage by changing the reference voltage of the bus converter 31. Since the reference voltage may be controlled with an analog voltage, the command of digital signal of the voltage control circuit 11 is converted into an analog signal by the DAC 12a.

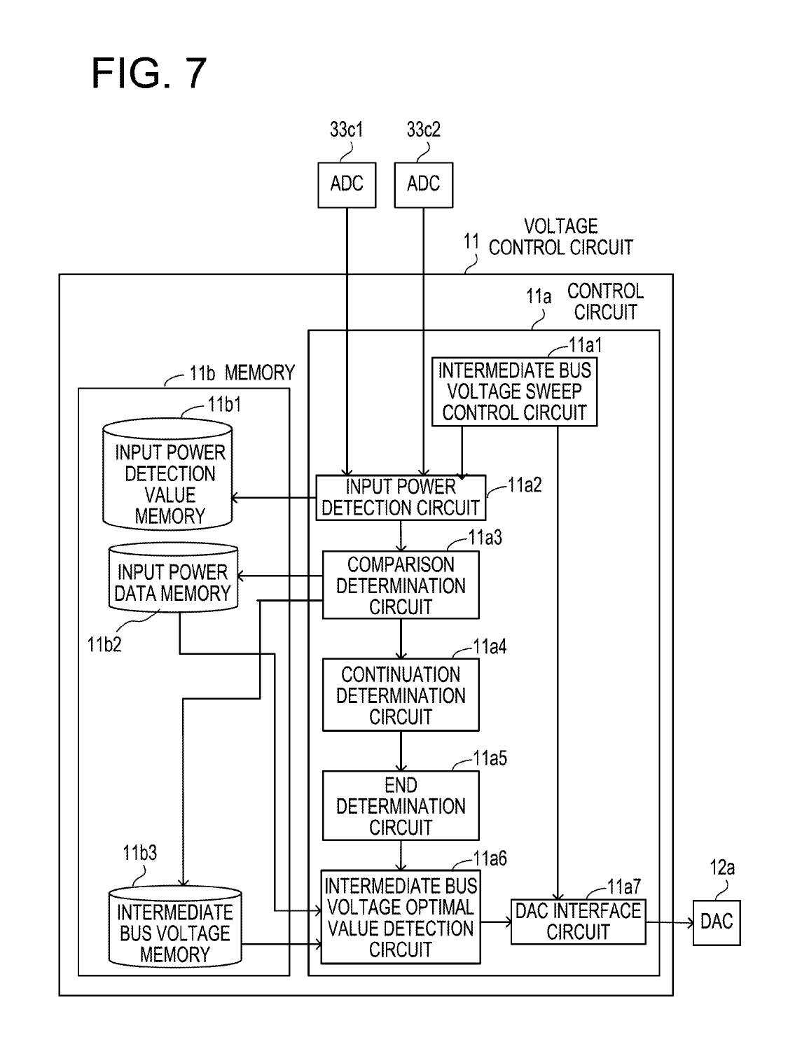

FIG. 7 is a view illustrating an example of functional blocks of the voltage control circuit. The voltage control circuit 11 includes a control circuit 11a and a memory 11b. The control circuit 11a implements the function of the control circuit 1a in FIG. 1A, and the memory 11b implements the function of the memory 1b in FIG. 1A.

The control circuit 11a includes an intermediate bus voltage sweep control circuit 11a1, an input power detection circuit 11a2, a comparison determination circuit 11a3, a continuation determination circuit 11a4, an end determination circuit 11a5, an intermediate bus voltage optimal value detection circuit 11a6, and a DAC interface circuit 11a7. The memory 11b includes an input power detection value memory 11b1, an input power data memory 11b2, and an intermediate bus voltage memory 11b3.

The intermediate bus voltage sweep control circuit 11a1 generates a command that sweeps an intermediate bus voltage to the bus converter 31. In this case, the intermediate bus voltage sweep control circuit 11a1 sets a start voltage (corresponding to the reference intermediate voltage) of the input power monitor to the intermediate bus voltage and performs sweep control to increase the intermediate bus voltage step by step while returning the intermediate bus voltage to the start voltage at a predetermined timing.

The input power detection circuit 11a2 detects the input power when the intermediate bus voltage is swept. In this case, the input power detection circuit 11a2 receives the input current signal output from the ADC 33c1 and the input voltage signal output from the ADC 33c2, and obtains the input power by digital calculation based on the values of the input current and the input voltage.

The comparison determination circuit 11a3 compares the input power detected at the start voltage and the input power detected when returning the intermediate bus voltage to the start voltage during the sweep of the intermediate bus voltage to determine whether the output power of the POL 32 is changed.

The continuation determination circuit 11a4 determines whether to continue the comparison of the input power targeted by the comparison determination circuit 11a3. For example, when comparison is made between the input power a1 detected at the start voltage and the input power a2 detected when the intermediate bus voltage is returned to the start voltage, the continuation determination circuit 11a4 determines whether to continue the comparison of the input powers a1 and a2 again.

The end determination circuit 11a5 makes a determination of the end of the input power monitoring. The intermediate bus voltage optimal value detection circuit 11a6 detects the minimum input power among the input power data stored in the input power data memory 11b2.

Then, the intermediate bus voltage optimal value detection circuit 11a6 acquires the intermediate bus voltage corresponding to the minimum input power from the intermediate bus voltage memory 11b3, and generates a command that sets the acquired intermediate bus voltage to the bus converter 31.

The DAC interface circuit 11a7 transmits the command from the intermediate bus voltage sweep control circuit 11a1 or the command from the intermediate bus voltage optimal value detection circuit 11a6 to the DAC 12a. Since these commands are digital commands, they are converted into analog commands by the DAC 12a.

The input power detection value memory 11b1 stores the input power detected by the input power detection circuit 11a2. The input power data memory 11b2 stores the input power when a change in the output power of the POL 32 is determined to be within an allowable range by the comparison determination circuit 11a3, as input power data. The intermediate bus voltage memory 11b3 stores the input power detection value and the intermediate bus voltage corresponding to the input power data.

### Hardware

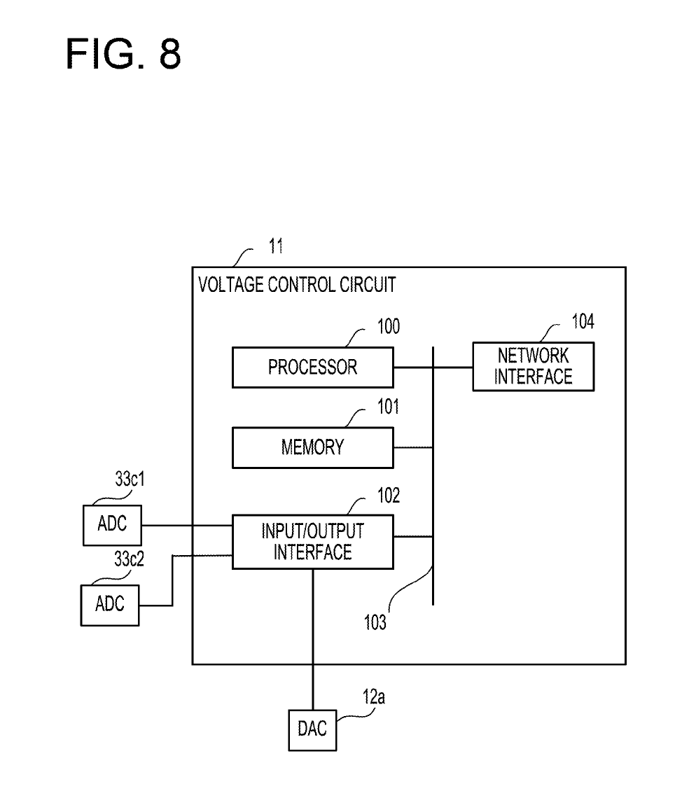

FIG. 8 is a view illustrating an example of a hardware configuration of the voltage control circuit. The voltage control circuit 11 is entirely controlled by a processor 100. The processor 100 executes the function of the control circuit 11a. A memory 101 and plural peripheral devices are coupled to the processor 100 via a bus 103. The processor 100 may be a multiprocessor.

The processor 100 is, for example, a CPU, an MPU (Micro Processing Unit), a DSP (Digital Signal Processor), an ASIC (Application Specific Integrated Circuit), or a PLD (Programmable Logic Device). Further, the processor 100 may be a combination of two or more elements of the CPU, MPU, DSP, ASIC, and PLD.

The memory 101 executes the function of the memory 11b and is used as a main storage device of the voltage control circuit 11. The memory 101 temporarily stores at least a part of an OS (Operating System) program and application programs to be executed by the processor 100. Various data required for processing by the processor 100 are stored in the memory 101.

The memory 101 is also used as an auxiliary storage device of the voltage control circuit 11 and stores an OS program, application programs, and various data. The memory 101 may include a semiconductor storage device such as a flash memory or an SSD (Solid State Drive), or a magnetic recording medium such as a HDD (Hard Disk Drive), as an auxiliary storage device.

As the peripheral devices coupled to the bus 103, there are an input/output interface 102 and a network interface 104. The input/output interface 102 performs interface control on the ADCs 33c1 and 33c2 and the DAC 12a.

Further, the input/output interface 102 is coupled to a monitor functioning as a display device which displays the state of the voltage control device 10 according to a command from the processor 100 (e.g., an LED (Light Emitting Diode) or an LCD (Liquid Crystal Display)).

Further, the input/output interface 102 may be coupled to information input devices such as a keyboard and a mouse, and transmits a signal sent from the information input device to the processor 100. The input/output interface 102 also functions as a communication interface that couples the peripheral devices. For example, the input/output interface 102 may be coupled to an optical drive device that reads data recorded on an optical disk by using laser light or the like. Examples of the optical disk include a Blu-ray® disc, a CD-ROM (Compact Disc Read Only Memory), and a CD-R (Recordable)/RW (Rewritable).

Further, the input/output interface 102 may be coupled to a memory device and a memory reader/writer. The memory device is a recording medium having a communication function with the input/output interface 102. The memory reader/writer is a device that writes data in a memory card or reads data from the memory card. The memory card is a card type recording medium.

The network interface 104 controls interface with a network when the voltage control device 10 is coupled to the network. The network interface 104 may be, for example, an NIC (Network Interface Card) or a wireless LAN (Local Area Network) card. Data received by the network interface 104 are output to the memory 101 and the processor 100.

With the above-described hardware configuration, the processing function of the voltage control circuit 11 may be implemented. For example, the voltage control circuit 11 may perform the intermediate bus voltage control of the present disclosure by the processor 100 that executes respective predetermined programs.

The voltage control circuit 11 implements the processing function of the present disclosure, for example, by executing a program recorded on a computer-readable recording medium. The program that describes the process contents to be executed by the voltage control circuit 11 may be recorded in various recording media.

For example, the program to be executed by the voltage control circuit 11 may be stored in an auxiliary storage device. The processor 100 loads at least a part of the program in the auxiliary storage device onto a main storage device and executes the program.

Further, the program may be recorded on a portable recording medium such as an optical disk, a memory device, or a memory card. The program stored in the portable recording medium may be executed after being installed in the auxiliary storage device, for example, under the control of the processor 100. Further, the processor 100 may read and execute the program directly from the portable recording medium.

### Operation of Determining Optimal Value of Intermediate Bus Voltage

FIG. 9 is a view for explaining an operation of determining the optimal value of the intermediate bus voltage. A graph g11 represents the sweep state of the intermediate bus voltage output from the bus converter 31 in which the vertical axis represents the intermediate bus voltage and the horizontal axis represents time. A graph g12 represents the sweep state of the input power of the bus converter 31 in which the vertical axis represents the input power and the horizontal axis represents the intermediate bus voltage.

[Step S11] In a period T0, the control circuit 11a sets an intermediate bus voltage V(0) as a start voltage (initial value) in the bus converter 31. Further, the control circuit 11a detects input power P(0) at the intermediate bus voltage V(0) in the period T0 and stores the input power P(0) in the input power data memory 11b2.

[Step S12a] The control circuit 11a causes the bus converter 31 to sweep the intermediate bus voltage V(0) to an intermediate bus voltage V(1) and output the intermediate bus voltage V(1). Further, the control circuit 11a detects input power PA(1) when the intermediate bus voltage V(1) is output from the bus converter 31, stores the input power PA(1) in the input power detection value memory 11b1.

[Step S13a] In a period T1, the control circuit 11a causes the bus converter 31 to return the intermediate bus voltage V(1) to the intermediate bus voltage V(0) and output the intermediate bus voltage V(0). Further, the control circuit 11a detects input power PB(1) when the intermediate bus voltage V(0) is output from the bus converter 31, and stores the input power PB(1) in the input power data memory 11b2.

[Step S14a] The control circuit 11a compares the input power P(0) detected in the period T0 with the input power PB(1) detected in the period T1. Then, the control circuit 11a determines whether a difference between the input power P(0) and the input power PB(1) is equal to or smaller than a threshold value.

When the difference is equal to or smaller than the threshold value, the control circuit 11a determines that a change in the output power of the POL 32 is within an allowable range, and stores the input power PA(1) in the input power data memory 11b2 as input power data P(1).

[Step S12b] The control circuit 11a causes the bus converter 31 to sweep the intermediate bus voltage V(0) to an intermediate bus voltage V(2) and output the intermediate bus voltage V(2). Further, the control circuit 11a detects input power PA(2) when the intermediate bus voltage V(2) is output from the bus converter 31, stores the input power PA(2) in the input power detection value memory 11b1.

[Step S13b] In a period T2, the control circuit 11a causes the bus converter 31 to return the intermediate bus voltage V(2) to the intermediate bus voltage V(0) and output the intermediate bus voltage V(0). Further, the control circuit 11a detects input power PB(2) when the intermediate bus voltage V(0) is output from the bus converter 31, and stores the input power PB(2) in the input power data memory 11b2.

[Step S14b] The control circuit 11a compares the input power P(0) detected in the period T0 with the input power PB(2) detected in the period T2. Then, the control circuit 11a determines whether a difference between the input power P(0) and the input power PB(2) is equal to or smaller than a threshold value.

When the difference is equal to or smaller than the threshold value, the control circuit 11a determines that a change in the output power of the POL 32 is within an allowable range, and stores the input power PA(2) in the input power data memory 11b2 as input power data P(2).

[Step S12c] The control circuit 11a causes the bus converter 31 to sweep the intermediate bus voltage V(0) to an intermediate bus voltage V(3) and output the intermediate bus voltage V(3). Further, the control circuit 11a detects input power PA(3) when the intermediate bus voltage V(3) is output from the bus converter 31, and stores the input power PA(3) in the input power detection value memory 11b1.

[Step S13c] In a period T3, the control circuit 11a causes the bus converter 31 to return the intermediate bus voltage V(3) to the intermediate bus voltage V(0) and output the intermediate bus voltage V(0). Further, the control circuit 11a detects input power PB(3) when the intermediate bus voltage V(0) is output from the bus converter 31, and stores the input power PB(3) in the input power data memory 11b2.

[Step S14c] The control circuit 11a compares the input power P(0) detected in the period T0 with the input power PB(3) detected in the period T3. Then, the control circuit 11a determines whether a difference between the input power P(0) and the input power PB(3) is equal to or smaller than a threshold value.

When the difference is equal to or smaller than the threshold value, the control circuit 11a determines that a change in the output power of the POL 32 is within an allowable range, and stores the input power PA(3) in the input power data memory 11b2 as input power data P(3).

[Step S12d] The control circuit 11a causes the bus converter 31 to sweep the intermediate bus voltage V(0) to an intermediate bus voltage V(4) and output the intermediate bus voltage V(4). Further, the control circuit 11a detects input power PA(4) when the intermediate bus voltage V(4) is output from the bus converter 31, and stores the input power PA(4) in the input power detection value memory 11b1.

[Step S13d] In a period T4, the control circuit 11a causes the bus converter 31 to return the intermediate bus voltage V(4) to the intermediate bus voltage V(0) and output the intermediate bus voltage V(0). Further, the control circuit 11a detects input power PB(4) when the intermediate bus voltage V(0) is output from the bus converter 31, and stores the input power PB(4) in the input power data memory 11b2.

[Step S14d] The control circuit 11a compares the input power P(0) detected in the period T0 with the input power PB(4) detected in the period T4. Then, the control circuit 11a determines whether a difference between the input power P(0) and the input power PB(4) is equal to or smaller than a threshold value.

When the difference is equal to or smaller than the threshold value, the control circuit 11a determines that a change in the output power of the POL 32 is within an allowable range, and stores the input power PA(4) in the input power data memory 11b2 as input power data P(4).

[Step S15] In a measurement period Tm1, the input power minimum value among the input powers stored in the input power data memory 11b2 is the input power P(2). Therefore, the control circuit 11a recognizes that the intermediate bus voltage V(2) at the input power P(2) is the optimal value that maximizes the conversion efficiency of the power supply circuit 30a, and controls the reference voltage of the bus converter 31 so that the intermediate bus voltage V(2) is output from the bus converter 31.

### Flowchart

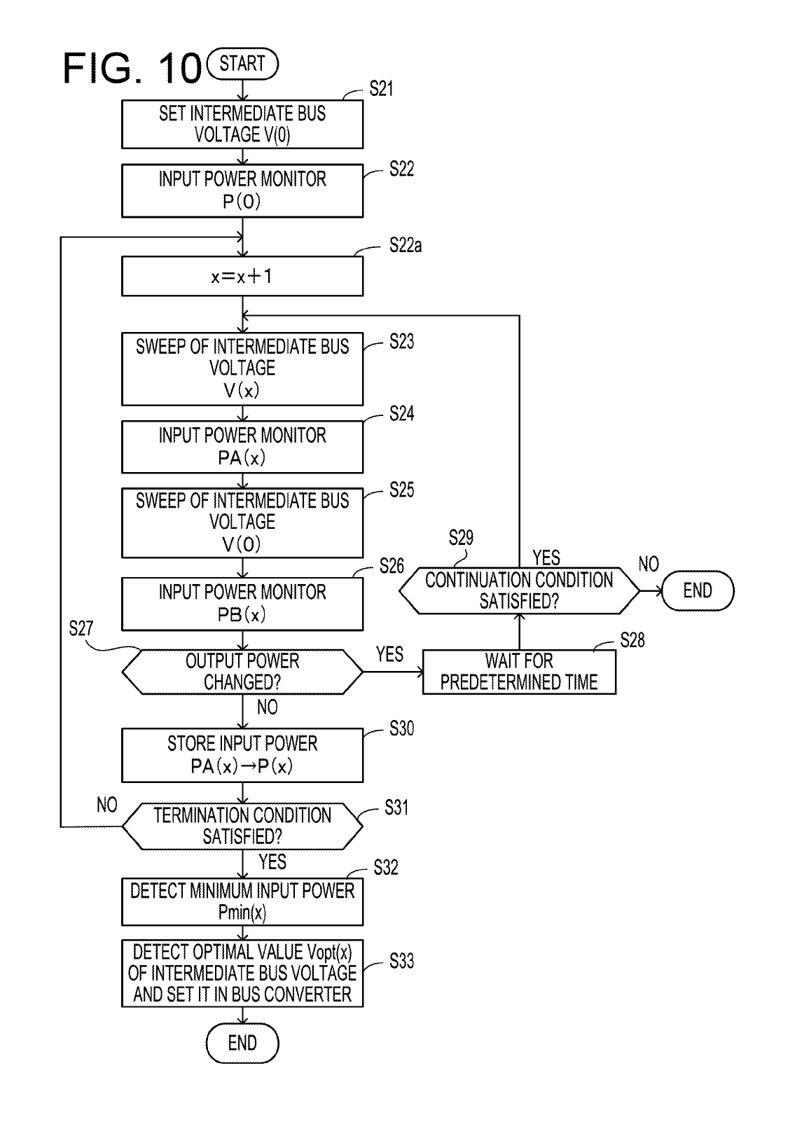

FIG. 10 is a flowchart illustrating an operation of determining the optimal value of the intermediate bus voltage.

[Step S21] The control circuit 11a sets the intermediate bus voltage V(0) in the bus converter 31 as a start voltage of the intermediate bus voltage.

[Step S22] The control circuit 11a detects the input power P(0) at the intermediate bus voltage V(0) and stores the input power P(0) in the input power detection value memory 11b1.

[Step S22a] The control circuit 11a increments a parameter x.

[Step S23] The control circuit 11a changes the intermediate bus voltage output from the bus converter 31 to an intermediate bus voltage V(x).

[Step S24] The control circuit 11a detects input power PA(x) at the intermediate bus voltage V(x) and stores the input power PA(x) in the input power detection value memory 11b1.

[Step S25] The control circuit 11a returns the intermediate bus voltage output from the bus converter 31 to the intermediate bus voltage V(0).

[Step S26] The control circuit 11a detects input power PB(x) at the intermediate bus voltage V(0) during the sweep period and stores the input power PB(x) in the input power detection value memory 11b1.

[Step S27] The control circuit 11a compares the input power P(0) with the input power PB(x) to obtain a difference therebetween. When the difference exceeds a threshold and it is determined that there is a change in the output power of the POL 32, the process proceeds to step S28. When the difference is equal to or smaller than the threshold and it is determined that the output power of the POL 32 is not changed (within the allowable range), the process proceeds to step S30.

[Step S28] The control circuit 11a operates a timer that counts a predetermined time to set the waiting time until the next process. A change in the output power may be caused by a temporary change due to, for example, disturbance. For this reason, when it is detected that there is a change in the output power, a predetermined waiting time for which disturbance is supposed to be cured is provided and the monitoring operation of the input power is resumed after the lapse of the waiting time.

[Step S29] The control circuit 11a determines whether the continuation condition is satisfied. When the continuation condition is not satisfied, the process (input power monitoring) is terminated. When the continuation condition is satisfied, the process returns to step S23.

An example of the continuation condition may be a determination on whether the continuous number of changes in the output power is equal to or smaller than a predetermined value. For example, when the number of changes in the output power is three or smaller consecutively, the control circuit 11a determines that the continuation condition is satisfied, and resumes the monitoring operation of the input power. When the number of changes in the output power is four or larger consecutively, the control circuit 11a determines that the continuation condition is not satisfied, stops resuming the monitor operation of the input power, and ends the control.

[Step S30] The control circuit 11a stores the input power PA(x) in the input power data memory 11b2 as input power data P(x).

[Step S31] The control circuit 11a determines whether the termination condition is satisfied. When the termination condition is not satisfied, the process returns to step S22a. When the termination condition is satisfied, the process proceeds to step S32.

The termination condition may be, for example, a determination on whether a measurement period of the input power monitoring has timed-up, or a determination on whether the number of times of monitoring of the input power has reached a predetermined value. For example, when the number of times of monitoring of the input power has reached the predetermined value, the control circuit 11a stops the monitoring operation of input power even when the termination condition is satisfied. When the number of times of monitoring of the input power is smaller than the predetermined value, the control circuit 11a determines that the termination condition is not satisfied, sweeps the intermediate bus voltage to a new value, and continues the monitoring operation of the input power.

[Step S32] The control circuit 11a selects the minimum input power Pmin(x) among the input power data P(0) to P(x) stored in the input power data memory 11b2.

[Step S33] The control circuit 11a selects an intermediate bus voltage corresponding to the input power Pmin(x) among the intermediate bus voltages stored in the intermediate bus voltage memory 11b3. The control circuit 11a sets the selected intermediate bus voltage as the optimal value Vopt(x) of the intermediate bus voltage that maximizes the conversion efficiency of the power supply circuit 30a. Then, the control circuit 11a transmits a command to the bus converter 31 to control the reference voltage of the bus converter 31 so that the intermediate bus voltage Vopt(x) is output from the bus converter 31.

### Modifications

As illustrated in FIG. 9, the intermediate bus voltage is swept once from the intermediate bus voltage V(0) and, every time the once-swept intermediate bus voltage is returned to the intermediate bus voltage V(0), it is detected whether the output power is changed.

In contrast, a modification involves sweeping the intermediate bus voltage plural times from the intermediate bus voltage V(0), returning the multiple-swept intermediate bus voltage to the intermediate bus voltage V(0), and detecting whether the output power is changed.

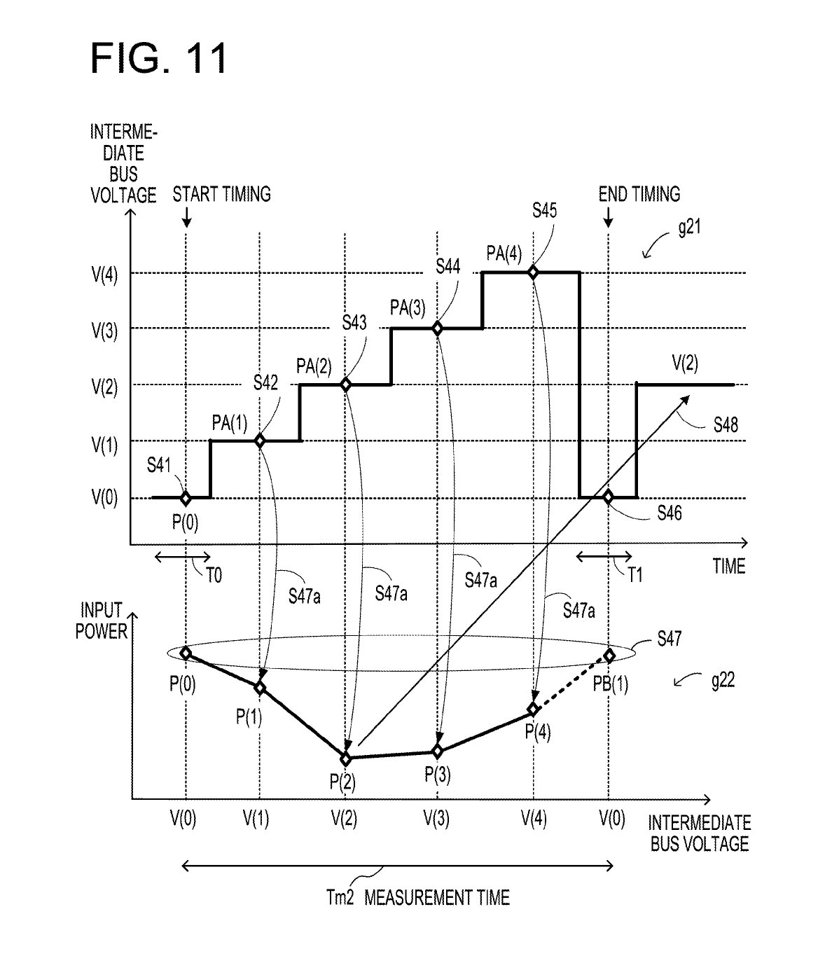

FIG. 11 is a view for explaining a modification of the operation of determining the optimal value of the intermediate bus voltage. A graph g21 represents the sweep state of the intermediate bus voltage output from the bus converter 31 in which the vertical axis represents the intermediate bus voltage, and the horizontal axis represents time. A graph g22 represents the sweep state of the input power of the bus converter 31 in which the vertical axis represents the input power, and the horizontal axis represents the intermediate bus voltage.

[Step S41] In a period T0, the control circuit 11a sets an intermediate bus voltage V(0) as a start voltage in the bus converter 31. Further, the control circuit 11a detects input power P(0) at the intermediate bus voltage V(0) and stores the input power P(0) in the input power data memory 11b2.

[Step S42] The control circuit 11a causes the bus converter 31 to sweep the intermediate bus voltage V(0) to an intermediate bus voltage V(1) and output the intermediate bus voltage V(1). Further, the control circuit 11a detects input power PA(1) when the intermediate bus voltage V(1) is output from the bus converter 31, and stores the input power PA(1) in the input power detection value memory 11b1.

[Step S43] The control circuit 11a causes the bus converter 31 to sweep the intermediate bus voltage V(1) to an intermediate bus voltage V(2) and output the intermediate bus voltage V(2). Further, the control circuit 11a detects input power PA(2) when the intermediate bus voltage V(2) is output from the bus converter 31, and stores the input power PA(2) in the input power detection value memory 11b1.

[Step S44] The control circuit 11a causes the bus converter 31 to sweep the intermediate bus voltage V(2) to an intermediate bus voltage V(3) and output the intermediate bus voltage V(3). Further, the control circuit 11a detects input power PA(3) when the intermediate bus voltage V(3) is output from the bus converter 31, and stores the input power PA(3) in the input power detection value memory 11b1.

[Step S45] The control circuit 11a causes the bus converter 31 to sweep the intermediate bus voltage V(3) to an intermediate bus voltage V(4) and output the intermediate bus voltage V(4). Further, the control circuit 11a detects input power PA(4) when the intermediate bus voltage V(4) is output from the bus converter 31, and stores the input power PA(4) in the input power detection value memory 11b1.

[Step S46] In a period T1, the control circuit 11a causes the bus converter 31 to return the intermediate bus voltage V(4) to the intermediate bus voltage V(0) and output the intermediate bus voltage V(0). Further, the control circuit 11a detects input power PB(1) when the intermediate bus voltage V(0) is output from the bus converter 31, and stores the input power PB(1) in the input power data memory 11b2.

[Step S47] The control circuit 11a compares the input power P(0) detected in the period T0 with the input power PB(1) detected in the period T1. Then, the control circuit 11a determines whether a difference between the input power P(0) and the input power PB(1) is equal to or smaller than a threshold value.

[Step S47a] When the difference is equal to or smaller than the threshold value, the control circuit 11a determines that a change in the output power of the POL 32 is within an allowable range, and stores the input powers PA(1), PA(2), PA(3), and PA(4) in the input power data memory 11b2 as input power data P(1), P(2), P(3), and P(4).

[Step S48] In a measurement period Tm2 from the start timing to the end timing, the input power minimum value is the input power P(2) among the input power data P(0), P(1), P(2), P(3), and P(4).

Therefore, the control circuit 11a recognizes that the intermediate bus voltage V(2) at the input power P(2) is the optimal value that maximizes the conversion efficiency of the power supply circuit 30a, and controls the reference voltage of the bus converter 31 so that the intermediate bus voltage V(2) is output from the bus converter 31.

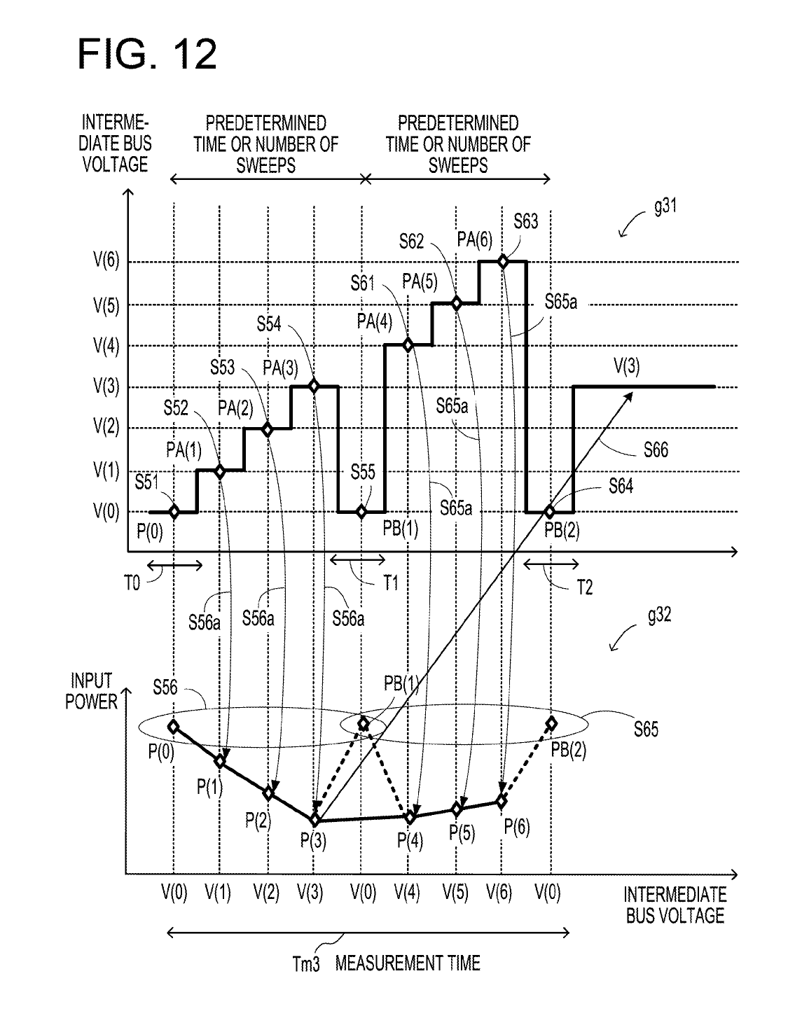

FIG. 12 is a view for explaining a modification of the operation of determining the optimal value of the intermediate bus voltage. A graph g31 represents the sweep state of the intermediate bus voltage output from the bus converter 31 in which the vertical axis represents the intermediate bus voltage, and the horizontal axis represents time. A graph g32 represents the sweep state of the input power of the bus converter 31 in which the vertical axis represents the input power, and the horizontal axis represents the intermediate bus voltage.

[Step S51] In a period T0, the control circuit 11a sets an intermediate bus voltage V(0) as a start voltage in the bus converter 31. Further, the control circuit 11a detects input power P(0) at the intermediate bus voltage V(0) and stores the input power P(0) in the input power data memory 11b2.

[Step S52] The control circuit 11a causes the bus converter 31 to sweep the intermediate bus voltage V(0) to an intermediate bus voltage V(1) and output the intermediate bus voltage V(1). Further, the control circuit 11a detects input power PA(1) when the intermediate bus voltage V(1) is output from the bus converter 31, and stores the input power PA(1) in the input power detection value memory 11b1.

[Step S53] The control circuit 11a causes the bus converter 31 to sweep the intermediate bus voltage V(1) to an intermediate bus voltage V(2) and output the intermediate bus voltage V(2). Further, the control circuit 11a detects input power PA(2) when the intermediate bus voltage V(2) is output from the bus converter 31, and stores the input power PA(2) in the input power detection value memory 11b1.

[Step S54] The control circuit 11a causes the bus converter 31 to sweep the intermediate bus voltage V(2) to an intermediate bus voltage V(3) and output the intermediate bus voltage V(3). Further, the control circuit 11a detects input power PA(3) when the intermediate bus voltage V(3) is output from the bus converter 31, and stores the input power PA(3) in the input power detection value memory 11b1.

[Step S55] In a period T1, the control circuit 11a causes the bus converter 31 to return the intermediate bus voltage V(3) to the intermediate bus voltage V(0) and output the intermediate bus voltage V(0). Further, the control circuit 11a detects input power PB(1) when the intermediate bus voltage V(0) is output from the bus converter 31, and stores the input power PB(1) in the input power data memory 11b2.

[Step S56] The control circuit 11a compares the input power P(0) detected in the period T0 with the input power PB(1) detected in the period T1. Then, the control circuit 11a determines whether a difference between the input power P(0) and the input power PB(1) is equal to or smaller than a threshold value.

[Step S56a] When the difference is equal to or smaller than the threshold value, the control circuit 11a determines that a change in the output power of the POL 32 is within an allowable range, and stores the input powers PA(1), PA(2), and PA(3) in the input power data memory 11b2 as input power data P(1), P(2), and P(3).

[Step S61] The control circuit 11a causes the bus converter 31 to sweep the intermediate bus voltage V(0) to an intermediate bus voltage V(4) and output the intermediate bus voltage V(4). Further, the control circuit 11a detects input power PA(4) when the intermediate bus voltage V(4) is output from the bus converter 31, and stores the input power PA(4) in the input power detection value memory 11b1.

[Step S62] The control circuit 11a causes the bus converter 31 to sweep the intermediate bus voltage V(4) to an intermediate bus voltage V(5) and output the intermediate bus voltage V(5). Further, the control circuit 11a detects input power PA(5) when the intermediate bus voltage V(5) is output from the bus converter 31, and stores the input power PA(5) in the input power detection value memory 11b1.

[Step S63] The control circuit 11a causes the bus converter 31 to sweep the intermediate bus voltage V(5) to an intermediate bus voltage V(6) and output the intermediate bus voltage V(6). Further, the control circuit 11a detects input power PA(6) when the intermediate bus voltage V(6) is output from the bus converter 31, and stores the input power PA(6) in the input power detection value memory 11b1.

[Step S64] In a period T2, the control circuit 11a causes the bus converter 31 to return the intermediate bus voltage V(6) to the intermediate bus voltage V(0) and output the intermediate bus voltage V(0). Further, the control circuit 11a detects input power PB(2) when the intermediate bus voltage V(0) is output from the bus converter 31, and stores the input power PB(2) in the input power data memory 11b2.

[Step S65] The control circuit 11a compares the input power PB(1) detected in the period T1 with the input power PB(2) detected in the period T2. Then, the control circuit 11a determines whether a difference between the input power PB(1) and the input power PB(2) is equal to or smaller than a threshold value.

[Step S65a] When the difference is equal to or smaller than the threshold value, the control circuit 11a determines that a change in the output power of the POL 32 is within an allowable range, and stores the input powers PA(4), PA(5) and PA(6) in the input power data memory 11b2 as input power data P(4), P(5) and P(6).

[Step S66] In a measurement period Tm3, the input power minimum value is the input power P(3). Therefore, the control circuit 11a recognizes that the intermediate bus voltage V(3) at the input power P(3) is the optimal value that maximizes the conversion efficiency of the power supply circuit 30a, and controls the reference voltage of the bus converter 31 so that the intermediate bus voltage V(3) is output from the bus converter 31.

The timing at which an intermediate bus voltage is swept from the intermediate bus voltage V(0) of the start voltage and is then returned back to the intermediate bus voltage V(0) may be set by time or by the number of sweeps.

In the case where the timing is set by time, for example, the intermediate bus voltage is swept step by step from the setting of intermediate bus voltage V(0) of the start voltage and is then returned to the intermediate bus voltage V(0) when a predetermined time has been reached, and a change in output power in this period is detected.

Alternatively, in the case where the timing is set by the number of sweeps, for example, the intermediate bus voltage is swept step by step N times from the setting of intermediate bus voltage V(0) of the start voltage and is then returned to the intermediate bus voltage V(0) when the N sweeps have been completed, and a change in output power in this period is detected.

### Effect Verification

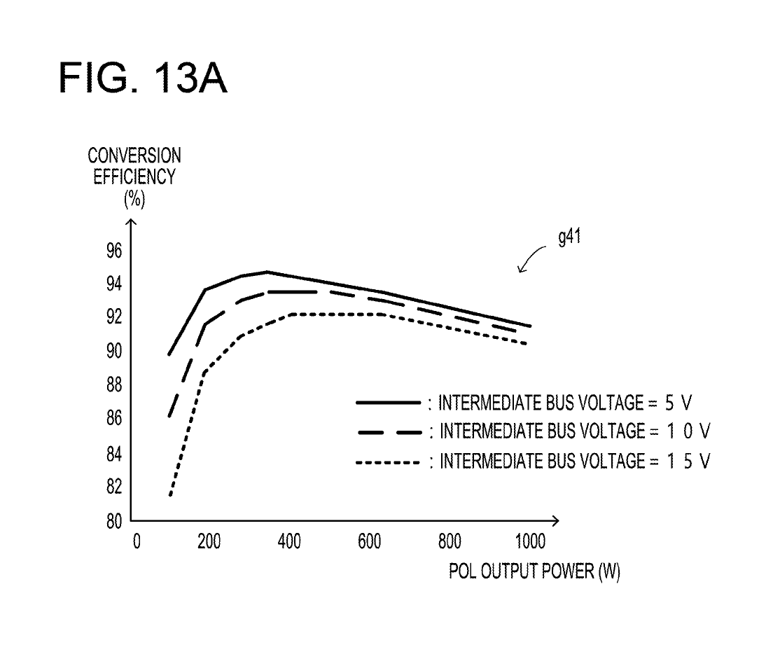

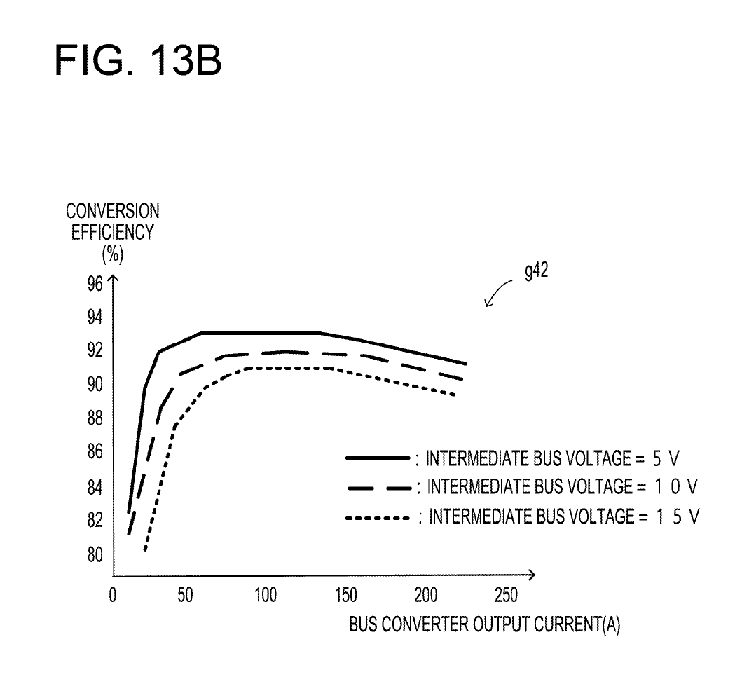

FIGS. 13A and 13B are views illustrating the conversion efficiency of the POL and the bus converter. In a graph g41, the vertical axis represents the conversion efficiency (%) and the horizontal axis represents POL output power (W). In a graph g42, the vertical axis represents the conversion efficiency (%) and the horizontal axis represents the bus converter output current (A). Both the graphs g41 and g42 represent the conversion efficiency when the intermediate bus voltage is 5V, 10V, and 15V.

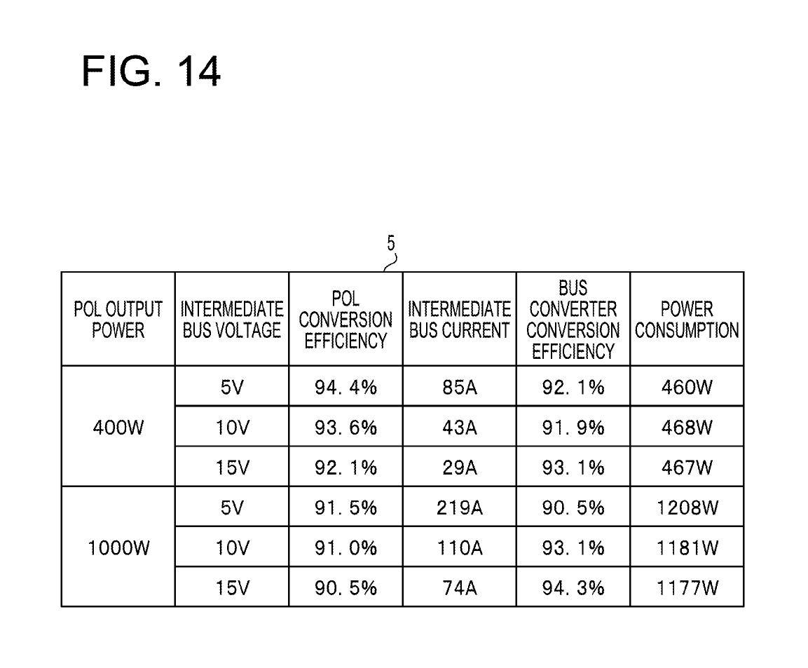

FIG. 14 is a view illustrating the relationship between the intermediate bus voltage and the power consumption. A table 5 represents the power consumption of the intermediate bus voltage when the power supply system is constituted by the bus converter and the POL. More specifically, the table 5 illustrates the intermediate bus voltage, the POL conversion efficiency, the intermediate bus current, the bus converter conversion efficiency, and the power consumption at the POL output power=400 W and 1,000 W.

By optimizing the intermediate bus voltage, it is possible to obtain an improvement effect of a maximum of 8 W under the condition of 400 W and a maximum of 31 W under the condition of 1,000 W. In the conditions of 400 W and 1,000 W, the optimal intermediate bus voltage is different, but the effect of low power consumption may be steadily obtained by repeating the control according to the device state.

The above-described processing functions of the voltage control apparatuses 1 and 10 of the present disclosure may be implemented by a computer. In this case, a program is provided to describe the processing contents of the functions that the voltage control apparatuses 1 and 10 need to have. When the program is executed by the computer, the processing functions are implemented on the computer.

The program that describe the processing contents may be recorded on a computer-readable recording medium. Examples of the computer-readable recording medium may include a magnetic storage device, an optical disk, a magneto-optical recording medium, and a semiconductor memory. Examples of the magnetic storage device may include a hard disk device (HDD), a flexible disk (FD), and a magnetic tape. Examples of the optical disk may include a CD-ROM/RW. Examples of the magneto-optical recording media may include an MO (Magneto Optical disk).

When the program is distributed, for example, a portable recording medium such as a CD-ROM recorded thereon with the program is available. Further, the program may be stored in a storage device of a server computer and may be transferred from the server computer to another computer via a network.

The computer that executes the program stores the program recorded on the portable recording medium or the program transferred from the server computer in its own storage device. Then, the computer reads the program from its own storage device and executes a process according to the read program. The computer may also read the program directly from the portable recording medium and execute a process according to the read program.

In addition, each time the program is transferred from the server computer connected via the network, the computer may sequentially execute process according to the received program. Further, at least a part of the above process functions may be implemented by electronic circuits such as DSP, ASIC, and PLD.

Although the embodiments have been exemplified above, the configuration of each of the parts described in the embodiments may be replaced with another one having the same function. In addition, any other components or steps may be added. Further, any two or more configurations (features) of the above embodiments may be used in proper combination.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A voltage control apparatus comprising:
a memory; and
a processor coupled to the memory and configured to:
set an intermediate voltage output from a first device of a device group in a first period to a first voltage which is input to a second device included in the device group,
change the intermediate voltage from the first voltage to a second voltage different from the first voltage,
return the second voltage in a second period to the first voltage,
detect a first input power of the first device when the first voltage is output from the first device in the first period,
detect a second input power of the first device when the first voltage is output from the first device in the second period,
monitor a change in an output power of the second device based on a difference between the first input power and the second input power,
detect a third input power of the first device when the second voltage is output from the first device,
detect a minimum input power of the first input power and the third input power, with an assumption that a change in the output power of the second device is allowable when the difference is equal to or smaller than a threshold value, and
control the intermediate voltage output by setting the intermediate voltage in the first device when the minimum input power is applied to the first device.

2. The voltage control apparatus according to claim 1, wherein the processor is configured to change the second voltage to a plurality of different voltages in a plurality of periods.

3. The voltage control apparatus according to claim 1, wherein the processor is configured to repeat a return to the first voltage after the changing from the first voltage to the second voltage.

4. The voltage control apparatus according to claim 1, wherein the processor is configured to repeat a return to the first voltage after changing from the first voltage to a plurality of voltages other than the first voltage sequentially.

5. The voltage control apparatus according to claim 1, wherein the first device is a bus converter and the second device is a load drive converter coupled by a bus to the first device to drive a load.

6. A voltage control method executed by a processor included in a voltage control apparatus, the method comprising:
providing a device group including a first device outputting an intermediate voltage and one or more second devices to which the intermediate voltage output from the first device is input;
setting the intermediate voltage of the first device in a first period to a first voltage which is input to a second device of the device group;
changing the intermediate voltage from the first voltage to a second voltage different from the first voltage;
returning the second voltage in a second period to the first voltage;
detecting a first input power of the first device when the first voltage is output from the first device in the first period;
detecting a second input power of the first device when the first voltage is output from the first device in the second period;
monitoring a change in an output power of the second device based on a difference between the first input power and the second input power;
detecting a third input power of the first device when the second voltage is output from the first device;
detecting a minimum input power of the first input power and the third input power, with an assumption that a change in the output power of the second device is allowable when the difference is equal to or smaller than a threshold value; and
controlling the intermediate voltage output by setting the intermediate voltage in the first device when the minimum input power is applied to the first device.

7. The voltage control method according to claim 6, further comprising:
changing the second voltage to a plurality of different voltages in a plurality of periods.

8. The voltage control method according to claim 6, further comprising:
repeating a transition to return to the first voltage after the transitioning from the first voltage to the second voltage.

9. The voltage control method according to claim 6, further comprising:
repeating a transition to return to the first voltage after transitioning from the first voltage to a plurality of voltages different from the first voltage sequentially.

10. The voltage control method according to claim 6, wherein the first device is a bus converter and the second device is a load drive converter coupled by a bus to the first device to drive a load.

11. A non-transitory computer-readable recording medium storing a program that causes a processor included in a voltage control apparatus to execute a process, the process comprising:
setting an intermediate voltage of a first device in a first period to a first voltage which is input to a second device of the device group;
changing the intermediate voltage from the first voltage to a second voltage different from the first voltage;
returning the second voltage in a second period to the first voltage;
detecting a first input power of the first device when the first voltage is output from the first device in the first period;
detecting a second input power of the first device when the first voltage is output from the first device in the second period;
monitoring a change in an output power of the second device based on a difference between the first input power and the second input power;
detecting a third input power of the first device when the second voltage is output from the first device;
detecting a minimum input power of the first input power and the third input power, with an assumption that a change in the output power of the second device is allowable when the difference is equal to or smaller than a threshold value; and
controlling the intermediate voltage output by setting the intermediate voltage in the first device when the minimum input power is applied to the first device.
